(19) United States
(12) Patent Application Publication
(10) Pub. No.: US 2008/0055364 A1
(43) Pub. Date: Mar. 6, 2008

(54) Large area array print head ejector actuation

(75) Inventor: Stanley W. Stephenson, Spencerport, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/516,134

(22) Filed: Sep. 6, 2006

(51) Int. Cl. B41J 2/04

(52) U.S. Cl. 347/54

(57) ABSTRACT

A print head includes a substrate, a plurality of row conductors arranged on the substrate, a plurality of column conductors arranged on the substrate, and a plurality of ejectors. Each of the plurality of ejectors includes a resistive element and is arranged on the substrate in rows and columns. Each resistive element is electrically connected to either one of the plurality of row conductors or one of the plurality of column conductors. A semiconductor device defines a current path for each resistive element and is electrically connected to each resistive element and to the other of either the one of the plurality of row conductors or one of the plurality of column conductors.

### CROSS REFERENCE TO RELATED APPLICATIONS

Reference is made to commonly-assigned, U.S. patent application Ser. No. ______ (Kodak Docket No. 90666), filed concurrently herewith, entitled “LARGE AREA ARRAY PRINT HEAD” in the name of Stanley W. Stephenson, the disclosure of which is incorporated herein by reference.

### FIELD OF THE INVENTION

This invention relates generally to the field of digitally controlled printing devices, and in particular to large area array print heads in which a plurality of ejectors are arranged in rows and columns.

### BACKGROUND OF THE INVENTION

Ink jet printing systems apply ink to a substrate. The inks are typically dyes and pigments in a fluid. The ink-receiving substrate can be comprised of a material or object. Most typically, the substrate is a flexible sheet that can be a paper, polymer or a composite of either type of material. The surface of the substrate and the ink are formulated to optimize the ink lay down.

Ink drops can be applied to the substrate by modulated deflection of a stream of ink (continuous) or by selective ejection from a drop generator (drop-on-demand). The drop-on-demand (DOD) systems eject ink using either a thermal pulse delivered by a resistor or a mechanical deflection of a cavity wall by a piezoelectric actuator. Ejection of the droplet is synchronized to motion of the substrate by a controller, which electrical signals to each ejector with appropriate timing to form an image.

U.S. Pat. No. 6,491,385 describes a continuous ink jet head and it's operation. A silicon substrate supports layers on the front surface having a pair of semi-circular resistive elements around each nozzle. Each nozzle has a unique supply bore through the substrate. A fluid, which can be ink, is forcibly ejected through the bore and through a nozzle formed in the layers on the front surface. Each resistor pair is pulsed to break the stream of fluid into discrete droplets. Asymmetric heating of the resistors can selectively direct the droplets into different pathways. A gutter can be used to filter out select droplets, providing a stream of selected droplets useful for printing. The modulated stream printing system requires significant additional apparatus to manage fluid flow.

Piezoelectric actuated heads use an electrically flexed membrane to pressurize a fluid-containing cavity. The membranes can be oriented in parallel or perpendicular to the ejection direction. U.S. Pat. No. 6,969,158 describes a piezoelectric drop-on-demand ink jet head having the membrane perpendicular to the droplet ejection direction. A set of plates is stacked up and includes plate of piezoelectric which flexes a pressure chamber parallel to the direction of ink ejection. The membranes require a large amount of surface area, and multiple rows of ejectors are arrayed in depth across the head. Ejectors are arranged across the printing direction at a pitch of 50 dpi and are arrayed in the printing direction 12 ejectors deep on an angle theta to form a head having an effective pitch of 600 dpi. Such heads are complex, requiring multiple layers that must be bonded together to form passages to the nozzle. The materials comprising the head and the structures do not lend themselves to incorporating semiconductor switching elements.

U.S. Pat. No. 6,926,284 discloses a drop-on-demand inkjet head permitting single-pass printing. A single pass print head comprises 12 linear array module assemblies that are attached to a common manifold/orifice plate assembly. Droplets are ejected from the orifice by twelve staggered linear array assemblies that support piezoelectric body assemblies to provide drop-on-demand ejection of ink through the orifice array. The piezoelectric system cannot pitch nozzles closely together; in the example, each swath module has a pitch of 50 dpi. The twelve array assemblies are necessary to provide 600 dpi resolution in a horizontally and vertically staggered fashion.

The orifice array on the plate can be a single two-dimensional array of orifices or a combination of orifices to form an array of nozzles. In the printing application, the orifices must be positioned such that the distance between orifices in adjacent line is at last an order of magnitude (more than ten times) the pitch between print lines. The assembly is quite complex, requiring many separate array assemblies to be attached to the orifice plate thorough the use of sub frames, stiffeners, clamp bar, washers and screws.

It would be advantageous to provide a staggered array in a unitary assembly with an integral orifice plate. It would be useful for the spacing between nozzles to be less than an order of magnitude deeper than is disclosed in this patent.

U.S. Pat. No. 6,722,759 describes a common thermal drop-on-demand inkjet head structure. The drop generator consists of ink chamber, an inlet to the ink chamber, a nozzle to direct the drop out of the cavity and a resistive element for creating an ink ejecting bubble. Linear arrays of drop generators are positioned on either side of an ink feed slot. Two linear arrays are fed by a common ink feed slot. Ink from the slot passes through a flow restricting ink channels to the ink chamber. A heater resistor at the bottom of the ink chamber is energized to form a bubble in the chamber and eject a drop of ink through a nozzle in the top of the chamber. The structure limits nozzles to be placed in linear rows on either side of the ink jet supply slot.

U.S. Pat. No. 5,134,425 discloses a passive two-dimensional array of heater resistors. The structure and arrangement of the droplet generators is not disclosed. The patent discloses the problem of power cross talk between resistors in two dimensional arrays of heater resistors. Voltages firing a resistor also apply partial voltages across unfired resistors. The parasitic voltage increases as the number of rows is increased to 5 rows. The patent applies partial voltages on certain lines to reduce the voltage cross talk. The partial energy does not eject a droplet, but maintains a common elevated temperature for both fired and unfired nozzles. Passive matrix arrays of resistors are limited in the depth of the array because of the parasitic resistance. The patent suggests that the number of rows is limited to less than five rows.

It would be useful to have a structure for an inkjet head that dispersed the nozzles in an array structure useful for high-speed printing. It would be useful to disperse ejectors in more than two columns. It would be useful for ejector arrays with a large number of rows to not have parasitic resistance.

### SUMMARY OF THE INVENTION

It is an object of this invention to provide an ink ejecting head having ejectors arrayed in many rows. It is an objective of this invention to fire the ejectors using a minimum amount of circuitry. It is an object of this invention to provide a set of nozzles with many rows without having a parasitic resistance problem.

According to one aspect of the invention, a print head includes a substrate, a plurality of row conductors arranged on the substrate, a plurality of column conductors arranged on the substrate, and a plurality of ejectors. Each of the plurality of ejectors includes a resistive element and is arranged on the substrate in rows and columns. Each resistive element is electrically connected to either one of the plurality of row conductors or one of the plurality of column conductors. A semiconductor device defines a current path for each resistive element and is electrically connected to each resistive element and to the other of either the one of the plurality of row conductors or one of the plurality of column conductors.

According to another aspect of the invention, a method of actuating print head ejectors includes providing a plurality of ejectors on a substrate, each of the plurality of ejectors including a resistive element, the plurality of ejectors arranged on the substrate in rows and columns, each resistive element being electrically connected to either one of a plurality of row conductors or one of a plurality of column conductors; providing a semiconductor device defining a current path for each resistive element, the semiconductor device being electrically connected to each resistive element and to the other of either the one of the plurality of row conductors or one of the plurality of column conductors; actuating a row of ejectors by providing a signal corresponding to an actuating state or a non-actuating state to each column conductor, and providing an enabling signal to one of the row conductors and a disabling signal to other row conductors; and actuating another row of ejectors by repeating steps a. and b. for another row of ejectors.

### BRIEF DESCRIPTION OF THE DRAWINGS

In the detailed description of the example embodiments of the invention presented below, reference is made to the accompanying drawings, in which:

FIG. 1 is a top schematic view of an ejector in accordance with the present invention;

FIG. 2 is a side sectional view through the ejector shown in FIG. 1;

FIG. 3 is a top view of an array of ink ejectors according to prior art;

FIG. 4 is a top view of a second embodiment of ejectors in accordance with prior art;

FIG. 5 is a top schematic view of an ejector in accordance with the present invention;

FIG. 6 is a schematic representation of an ejector array in accordance one example embodiment of the invention;

FIG. 7 is a schematic representation of an ejector array in accordance another example embodiment of the invention;

FIG. 8 is an electrical schematic of an ink jet head in accordance with the present invention;

FIG. 9 is a schematic view of a head assembly in accordance with the present invention; and

FIG. 10 is a side view of a printer using a head in accordance with the present invention.

### DETAILED DESCRIPTION OF THE PREFERRED EMBODIMENT

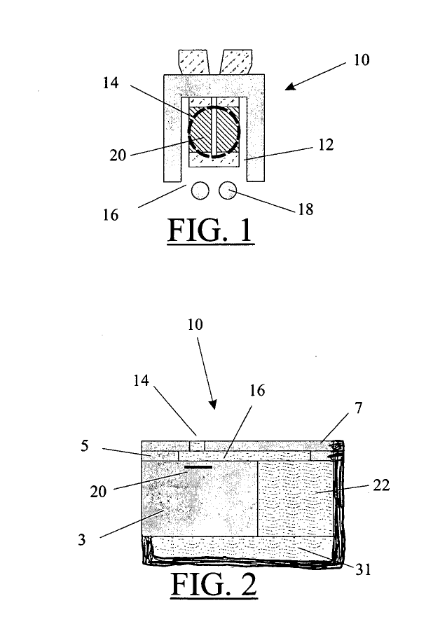

FIG. 1 is a top schematic view of an ejector 10 in accordance with the present invention. FIG. 2 is a side sectional view through the ejector shown in FIG. 1. A substrate 3 supports a polymer layer 5. Substrate 3 is most commonly a silicon wafer, however substrate 3 can be made of glass or metal such as stainless steel, Invar, or nickel. Substrate 3 can also be a monolithic substrate, for example, a single crystalline semiconductor material such as silicon. An ink chamber 12 is formed as a cavity in polymer layer 5 to hold a printing ink. A cover 7 over ink chamber 12 can be formed directly over polymer layer 5 using a vacuum deposited ceramic or metal. Cover 7 over ink chamber 12 can be a separate plate formed of ceramic or metal which is bonded to the polymer layer 5 to define ink chamber 12. Cover 7 has an opening to form nozzle 14 to direct ejected droplets of ink in a specified direction when ink chamber 12 is pressurized.

A heater resistor 20 is embedded in the substrate 3. A pulse of electrical energy to heater resistor 20 causes ink within ink chamber 12 to momentarily be converted into a gaseous state. A gas bubble is formed over heater resistor 20 within ink chamber 12, and pressurizes ink chamber 12. Pressure within ink chamber 12 acts on ink within ink chamber 12 and forces a droplet of ink to be ejected through nozzle 14. Inlet 16 supplies ink to ink chamber 12. Restriction 18 can be formed at inlet 16 to improve firing efficiency by restricting the majority of the pressure pulse to ink chamber 12. Restriction 18 can be in the form of one or more pillars formed within inlet 16, or by a narrowing of the side walls in polymer layer 5 at inlet 16 of ink chamber 12.

Resistive heads are commonly made using silicon for substrate 3. Heater resistor 20 and associated layers are formed over substrate 3, followed by polymer layer 5. Polymer layer 5 is patterned, followed by cover 7, which is patterned to form nozzle 14. After those layers have been formed, ink feed slot 22 is formed through substrate 3 using a reactive ion milling process. The reactive ion milling process has the characteristic of forming near-vertical walls through a silicon substrate 3. The ion milling process has the virtue that the process is specific to silicon and can be form ink feed slot 22 without damage to structures associated with ejectors 10 on substrate 3. Substrate 3 is bonded to a structure that has one or more cavities in head holder 31 for supplying ink to some or all of ejectors 10 formed on substrate 3.

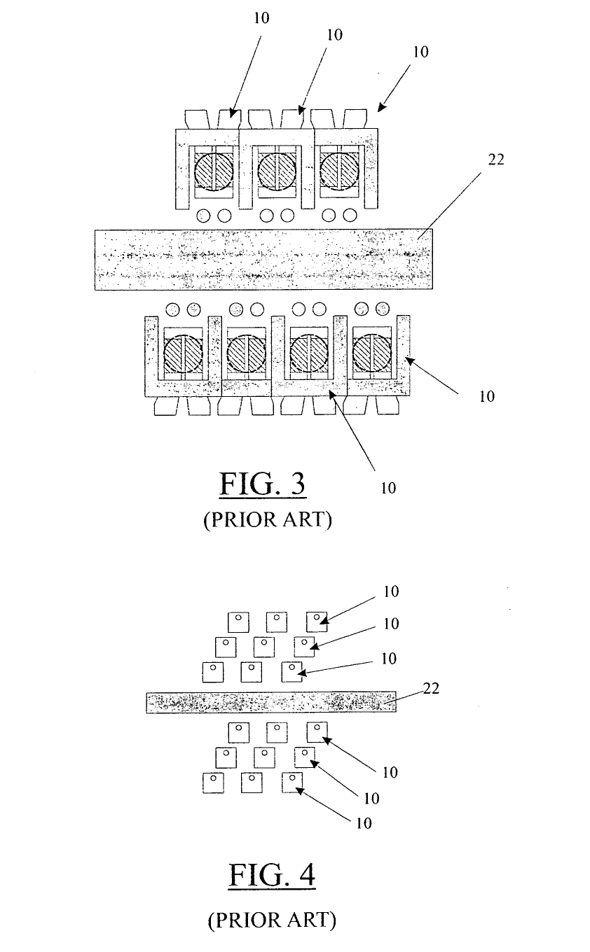

FIG. 3 is a top view of an array of ink ejectors according to prior art. Ejectors 10 must be supplied by ink from the rear side of substrate 3. U.S. Pat. No. 6,722,759 describes how ink is currently supplied in thermal drop-on-demand inkjet heads. Ejectors 10 are arranged in two closely packed rows which share a common ink feed slot 22. Ink feed slot 22 passes through substrate 3, which supports ejectors 10. FIG. 4 is a top view of a second embodiment of ejectors in accordance with prior art as disclosed in EP 1,563,999 A2. In that patent, a common ink feed slot 22 supplies ejectors 10. Ejectors 10 are not in a strictly linear row, but are progressively offset depth wise in groups of three ejectors.

Arranging two linear rows of ejectors 10 on either side of ink feed slot 22 provides for a compact ink jet head. Because the nozzles are adjacent to each other, fluidic cross-talk can occur between the ejectors. Close packing of the nozzles makes the head susceptible to thermal cross talk between adjacent nozzles. Overheating can become more pronounced if substrate 3 is not silicon, but a less thermally conductive material such as glass, ceramic or metal.

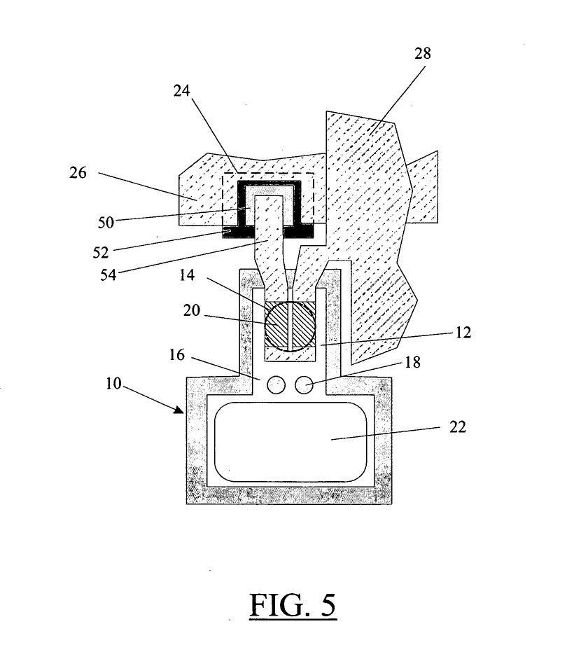

FIG. 5 is a top schematic view of an ejector in accordance with the present invention. In the invention, an ejector 10 comprises an ink chamber 12 actuated by heater resistor 20. Ink chamber 12 is fed by inlet 16 and ejects fluid through nozzle 14. A restriction 18 can be formed at the inlet to improve ejector 10's performance. A dedicated ink feed slot 22 is integral with ejector 10. In the case that substrate 3 is made of silicon, a reactive ion etching process creates a substantially columnar ink feed slot 22 through substrate 3. Each ink feed slot 22 shares a common cavity in head holder 31 facing the back of substrate 3. Ejector 10 in accordance with the invention provides a complete assembly that can be positioned at any distance from adjacent ejectors 10 to eliminate fluidic cross talk and improve cooling efficiency. In the case that substrate 3 is not silicon, the greater distance prevents overheating that would result from closely spaced ejectors 10 on lower conductivity substrates 3.

U.S. Pat. No. 5,134,425 discloses a passive two-dimensional array of heater resistors. The patent discloses the problem of power cross talk between resistors in two-dimensional arrays of heater resistors. A voltage applied to one resistor applies partial voltages across unfired resistors, significantly increasing the current and power demand. In FIG. 5, ejector 10 is connected to row conductor 26 and column conductor 28. A semiconductor device, for example, a two terminal device such as a diode 24, permits multiple ejectors 10 to be attached to a matrix of row conductors 26 and column conductors 28. The diodes block current flows to parasitic elements, reducing power demand of the device. The diodes permit large number of columns to be used on the head.

Diode 24 can be fabricated in several ways. For example, when substrate 3 is a single crystalline semiconductor material, for example, silicon, diode 24 can be included in substrate 3 by appropriately doping a portion of the single crystalline semiconductor material. Alternatively, diode 24 can be arranged over substrate 3 and be formed by a plurality of thin film material layers electrically isolated from substrate 3.

When substrate 3 is silicon, diodes 24 can be formed in the silicon using overlapping p-doped and n-doped areas to form a diode. In the exemplary embodiment, a smaller well of a first doped area 50 sits in a deeper area of material having second doped area 52 having a complementary doping to first area 50. Row conductor 26 contacts second doped area 52 and heater resistor 20 is connected to first doped area 50 by diode contact 54. If substrate 3 is not a semiconducting material, then thin-film diodes can be formed using thin semiconducting films having positive and negatively doped regions to form diode 24. Diode 24 permits fabrication of matrices of ejectors 10 having a large number of columns and rows without parasitic resistance. Diodes require fewer and simpler processing steps than transistors, which are used in linearly arrayed thermal ink jets heads as shown in FIG. 3 and FIG. 4. The diode array overcomes limitations of the passive matrix design in heads with less complexity than other thermal DOD inkjet heads.

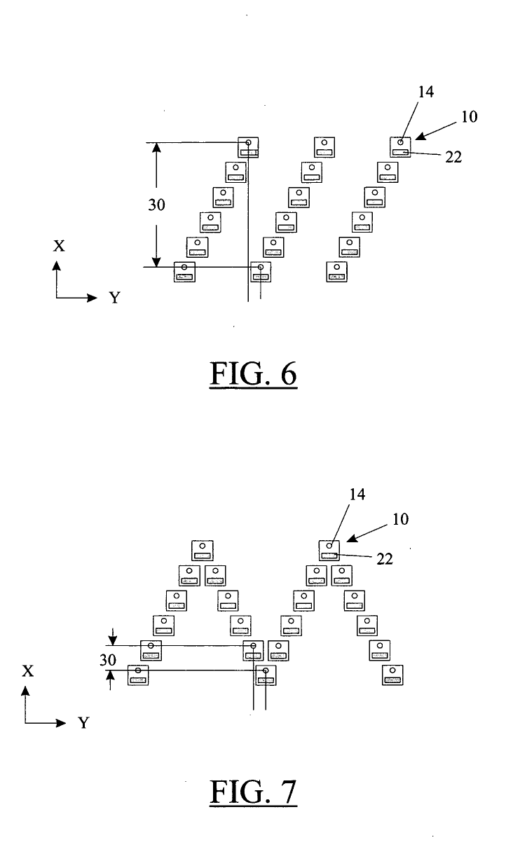

FIG. 6 is a schematic representation of an ejector array in accordance one example embodiment of the invention. A coordinate system is shown and includes a first direction X with X an axis of motion between the printhead and an ink-receiving surface. This is commonly referred to as a printing direction. A second direction Y is also shown with Y being a cross printing direction. A direction Z is also shown with Z being a direction perpendicular to the printhead. This is commonly referred to as the direction of ink drop ejection from the printhead.

Ejectors 10 are shown schematically as a box having individual supply ports 22 and ejectors 14. Ejectors 10 have been attached to a matrix of row conductors 26 and column conductors 28 to form laterally staggered columns of ejectors 10. Each ejector 10 of a column of ejectors is staggered at a desired pitch, typically expressed in dpi or microns, which is finer than the pitch of the ejector columns. For example, each column can be pitched 600 microns apart due to the area required for each ejector. If the required printing pitch is 40 microns, each ejector in the column can be laterally staggered 40 microns to a depth of 15 ejectors (40×15=600) to achieve the required 40 micron printing pitch.

In FIG. 6, six ejectors are shown in each laterally staggered column, however, each laterally staggered column can include more than six ejectors or less than six ejectors. The lateral staggering at a given number of levels provides room for each ejector 10 at high lateral resolution. This pattern includes a relatively large spacing distance 30 between adjacent columns—the last ejector of a group and the first ejector of the following group. The relatively large spacing distance 30 may require precise orientation of the print head having such spacing to the axis of motion of the print head relative to an ink receiver 40. If the orientation is off-axis by too much of an angle, either an unprinted line or double hit line will occur while printing.

FIG. 7 is a schematic representation of an ejector array in accordance another example embodiment of the invention. In FIG. 7, ejectors 10 are arranged to a given depth, for example, six deep, and maintain a minimal spacing distance 30 between ejectors. The ejectors form a zigzag pattern that follows a course that includes at least one turn in alternating direction. Typically, the at least one turn occurs for nozzles subsequent to nozzles at either extreme end of depth.

This pattern reduces the accuracy requirements for rotational alignment of the print head, thereby reducing errors during printing. Rotation of the print head around the z-axis can result in banding during printing. Minimizing spacing distance 30 reduces the requirements for accuracy of the rotational alignment requirements for the printhead.

The embodiments shown in FIGS. 6 and 7 are particularly well suited for print heads having large area arrays, for example, print heads having a length dimension of four inches and a width dimension of one inch. However, the large area array print head can have other length and width dimensions. One (or a plurality of large area array print heads stitched together) can be used to form a pagewide print head.

In a pagewide print head, the length of the printhead is preferably at least equal to the width of the receiver and does not “scan” during printing. The length of the page wide printhead is scalable depending on the specific application contemplated and, as such, can range from less than one inch to lengths exceeding twenty inches.

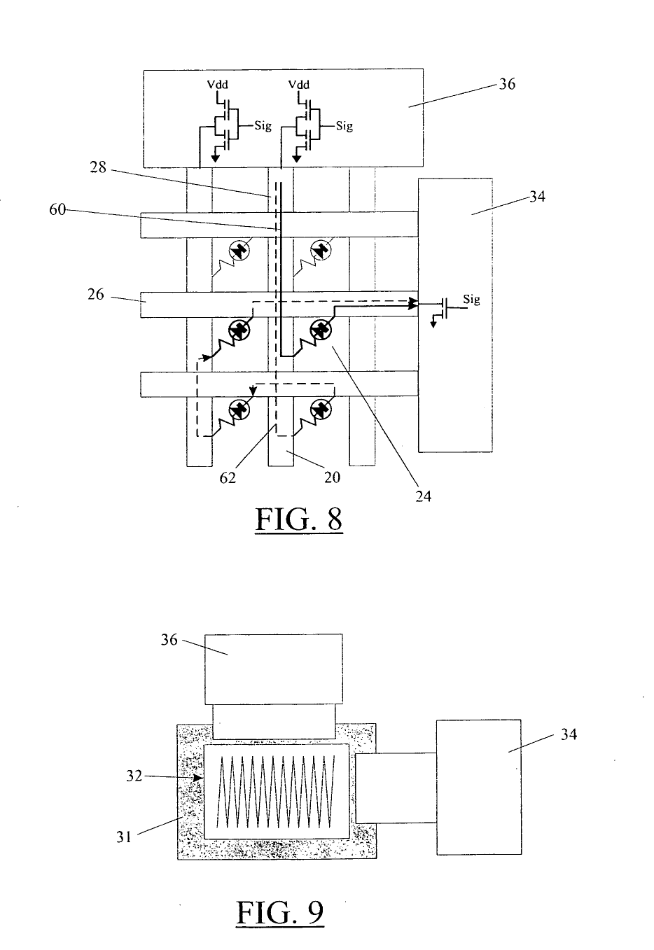

FIG. 8 is an electrical schematic of an ink jet head in accordance with the present invention. Print head 32 includes a plurality of drivers electrically connected to the plurality of row conductors and the plurality of column conductors. The plurality of drivers are operable to provide current to each resistive element sequentially. In FIG. 8, each column conductor 28 is connected to a column driver 36. Column driver 36 can be, for example, an ST Microelectronics STV 7612 Plasma Display Panel Diver chip that is connected to each column conductor 28. The chip responds to digital signals to either apply a drive voltage or ground to each column conductors. Each row conductor 26 is connected to a row driver 34. Row driver 34 can be a ST Microelectronics L6451 28 Channel Ink Jet Driver chip that provides a DMOS power transistor to each row conductor 26. Diode 24, provided with each ejector 10, provides logic to permit print head 32 to be logically driven in a sequential fashion without parasitic resistance effects.

Print head 32 is fired row sequentially. Row driver 34 applies a ground voltage to a row of ejectors 10. Column driver 36 is operable to switch between a high voltage state and a low voltage state such as ground. Digital signals apply a drive voltage (Vdd) or ground voltage to each column conductor 28. Column conductors 28 having an applied drive voltage provide energy to the ejector attached to column conductor 28 and the grounded row conductor 26. Column conductors 28 having a ground voltage are not fired.

Row driver 34 is operable to switch between a high impedance state and a low voltage state such as ground. Only one row conductor 26 at a time has a ground voltage, the other row conductors are attached to high impedance drivers and do not conduct current. Row driver 34 must simultaneously sink the current of all activated heater resistors on the row. Row driver 34 is used based on its ability to sink large amounts of current. Row conductors 26 are grounded sequentially, and column conductors 36 are set to a state that corresponds to a row of ejectors being activated or not activated. This process is repeated to apply an image wise pattern of ink droplets from print head 32.

Drive path 60 for indicated drive resistor 24 is shown as a solid line. A parasitic path 62 is shown as a dotted line. When drive voltage Vdd is applied to column conductor 28 drive voltage is applied to all heater resistors 20 on that column. The voltage potential is applied across all ungrounded rows 26 though the heater resistors 24 on a column 20 having an applied voltage Vdd. However, diodes 24 on all rows prevent any current from flowing through reverse biased heater resistors 24, and the other heater resistors 24 do not heat. In the specific embodiment, the row driver 34 is either open or grounded. The current that is sunk by each row is the sums of all drive currents on heater resistors 24 across the row. In a head having thirty activated heater resistors 24 on a line, each sinking 50 milli-amperes, each row driver may sink up to 1.5 amps.

Alternatively, row driver 34 can be a chip that switches each line between Vdd and ground. In that case, ail row conductors 26 are held at Vdd, and an activated row is switched to ground. Diode 24 is required in this case to prevent heater resistors 24 from being fired by a backward flowing parasitic current. The alternative configuration has the advantage that row driver 36 does not to apply charge to bring non-energized row conductors to Vdd.

FIG. 9 is a schematic view of a head assembly in accordance with the present invention. Substrate 3 has been mounted to head holder, which holds a supply of ink in a cavity behind substrate 3 to supply ink through substrate 3 to ejectors 10 mounted on the front of substrate 3. Row driver 34 and column driver 36 are attached to head holder 31 and wire bonds made between the flex circuit for the drivers to the row and column conductors on print head 32. The width of the head is not limited to a single row driver 36. The width can be extended and additional row drivers 36 added to provide power to additional columns.

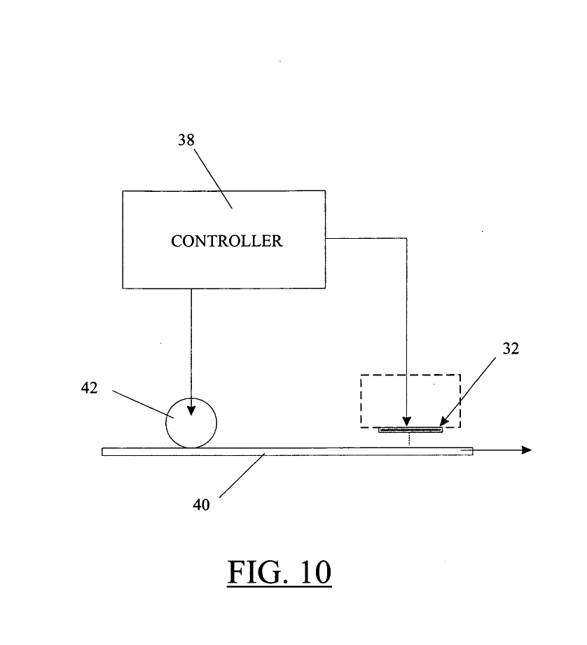

FIG. 10 is a schematic side view of a printer using a head in accordance with the present invention. Controller 38 moves an ink receiver 40 using receiver driver 42. Receiver driver 42 is a motor that operates on a plate or roller to drive ink receiver 40 under print head 32. Controller 38 provides drive signals to row driver 34 and column driver 36 connected to print head 32 to apply an image-wise pattern of ink droplets onto ink receiver 40 in synchronization with the motion of ink receiver 40.

The invention has been described in detail with particular reference to certain preferred embodiments thereof, but it will be understood that variations and modifications can be effected within the scope of the invention.

### PARTS LIST

3 substrate
5 polymer layer
7 cover
10 ejector
12 ink chamber
14 nozzle
16 inlet
18 restriction
20 heater resistor
22 ink feed slot
24 diode
26 row conductor
28 column conductor
30 spacing distance
31 head holder
32 print head
34 row drivers
36 column drivers
38 controller
40 ink receiver
42 receiver driver
50 first doped area
52 second doped area
54 diode contact
60 drive path
62 parasitic path

What is claimed is:

1. A print head comprising:
a substrate;
a plurality of row conductors arranged on the substrate;
a plurality of column conductors arranged on the substrate;
a plurality of ejectors, each of the plurality of ejectors including a resistive element, the plurality of ejectors arranged on the substrate in rows and columns, each resistive element being electrically connected to either one of the plurality of row conductors or one of the plurality of column conductors; and
a semiconductor device defining a current path for each resistive element, the semiconductor device being electrically connected to each resistive element and to the other of either the one of the plurality of row conductors or one of the plurality of column conductors.

2. The print head of claim 1, wherein the semiconductor device includes a two terminal device.

3. The print head of claim 2, wherein the two terminal device is a diode.

4. The print head of claim 3, wherein the substrate is a single crystalline semiconductor material and the diode is included in the substrate.

5. The print head of claim 4, wherein the single crystalline semiconductor material is silicon.

6. The print head of claim 3, wherein the diode is arranged over the substrate and includes a plurality of thin film material layers electrically isolated from the substrate.

7. The print head of claim 1, further comprising a plurality of drivers electrically connected to the plurality of row conductors and the plurality of column conductors, the plurality of drivers being operable to provide current to each resistive element sequentially.

8. The print head of claim 7, wherein one of the plurality of drivers is operable to switch between a high voltage state and a low voltage state.

9. The print head of claim 7, wherein one of the plurality of drivers is operable to switch between a high impedance state and a low voltage state.

10. A method of actuating print head ejectors comprising:
providing a plurality of ejectors on a substrate, each of the plurality of ejectors including a resistive element, the plurality of ejectors arranged on the substrate in rows and columns, each resistive element being electrically connected to either one of a plurality of row conductors or one of a plurality of column conductors;
providing a semiconductor device defining a current path for each resistive element, the semiconductor device being electrically connected to each resistive element and to the other of either the one of the plurality of row conductors or one of the plurality of column conductors; and
actuating a row of ejectors by
a. providing a signal corresponding to an actuating state or a non-actuating state to each column conductor; and
b. providing an enabling signal to one of the row conductors and a disabling signal to other row conductors; and
actuating another row of ejectors by repeating steps a. and b. for another row of ejectors.

11. The method of claim 10, further comprising:
sequentially repeating steps a. and b. for each of the plurality of ejectors.
